(19) United States
(12) Patent Application Publication
(10) Pub. No.: US 2013/0259100 A1
(43) Pub. Date: Oct. 3, 2013

(54) INFORMATION PROCESSING APPARATUS, TESTING METHOD, AND COMPUTER-READABLE RECORDING MEDIUM HAVING STORED THEREIN TESTING PROGRAM

(71) Applicant: FUJITSU LIMITED, Kawasaki-shi (JP)

(72) Inventor: Teruaki ICHIKAWA, Yokohama (JP)

(21) Appl. No.: 13/723,265

(22) Filed: Dec. 21, 2012

(30) Foreign Application Priority Data
Mar. 27, 2012 (JP) 2012-071197

(51) Int. Cl. H04L 1/22

(52) U.S. Cl. CPC H04L 1/22
USPC 375/219

(57) ABSTRACT

A first transmitting device includes: a controller that generates setting information concerning transmission and reception of data in the first and second transmitting devices and transmits the generated setting information to the second transmitting device; a detector that detects whether an error is included in data which is transmitted from the second transmitting device and received based on the setting information; and a storage unit that stores information on the error detected by the detector. A second transmitting device includes: a setting unit that sets transmission of data to be transmitted to the first transmitting device based on the setting information received from the controller; and a generator that generates data in accordance with the setting by the setting unit to transmit the data to the first transmitting device.

### CROSS-REFERENCE TO RELATED APPLICATION

This application is based upon and claims the benefit of priority of the prior Japanese Patent Application No. 2012-071197, filed on Mar. 27, 2012, the entire contents of which are incorporated herein by reference.

### FIELD

The embodiments discussed herein are directed to an information processing apparatus, a testing method, and a computer readable recording medium having stored therein a testing program.

### BACKGROUND

In order to rapidly transmit a signal between internal or peripheral devices of an information processing apparatus, high speed serial transfer is performed through a communication line. In the high speed serial transfer, in order to obtain a preferable transmission characteristic suitable for the system, waveform adjustment such as emphasis or equalizing may be performed on a signal to be transmitted or received signal in at least one of a transmitter or a receiver of each device.

The transmitter or the receiver performs the waveform adjustment on the signal to be transmitted or received signal based on a predetermined setting (adjusting) parameter. The setting parameter includes a setting value such as amplification of a signal or adjustment of a phase in the transmitter or the receiver. An optimal value of the setting parameter is preferably determined in accordance with a characteristic of a communication line that connects devices. For example, the optimal setting parameter is searched by a test and determined from enormous setting patterns by an operator such as a designer or a manufacturing manager when an information processing apparatus or a peripheral device is designed or manufactured.

FIG. 14 is a view to explain an example of a procedure of determining a setting parameter. As illustrated in FIG. 14, the information processing apparatus 100 includes devices 200 and 300 which are connected by a communication line 1000. A console 400a that sets a setting parameter of a Tx (transmitter) 240 and an Rx (receiver) 250 of the device 200 is connected to the device 200. Further, a console 400b that sets a setting parameter of a Tx (transmitter) 340 and an Rx (receiver) 350 of the device 300 is connected to the device 300.

The device 200 transmits a signal to the Rx 350 through a transmission channel 1200 by the Tx 240 and receives a signal transmitted from the Tx 340 through a transmission channel 1100 by the Rx 250 to perform a high speed serial transfer of a signal with the device 300.

In the example illustrated in FIG. 14, in order to determine the setting parameter, for example, the operator sets an initial parameter in the device 200 through the console 400a and sets a parameter in the device 300 through the console 400b. Therefore, the operator changes a parameter of the device 200 while fixing a parameter of the device 300 and performs the transmission test whenever the parameter of the device 200 is changed. When the parameter of the device 200 is changed up to a predetermined value, the operator changes the parameter of the device 300 and then repeats the transmission test in which the parameter of the device 200 is changed to perform the test using a plurality of setting patterns. Accordingly, the operator obtains a parameter having an optimal (preferable) testing result, that is, transmission result of the signal and sets the parameter in the transmitter and the receiver of each of the devices 200 and 300.

Further, as a related technology, a technology in that a device transmits sample data while changing the setting of an output amplitude and an emphasis of the transmitter in a predetermined range and the other device detects and transmits a receivable phase range data based on an eye diagram generated from the sample data which is received by the receiver is known. In this technology, the device writes phase range data transmitted from the other device in a table and determines optimal values of an output amplitude and an emphasis from a table obtained when the setting is completely changed in a predetermined range to be set in the transmitter.

Further, as another related technology, in order to prevent the deterioration of a signal quality for the transmission of a plurality of storage devices, a technology in that a storage device system inputs a signal which is exchanged between a plurality of storage devices and a plurality of system side communicating units and corrects the input signal based on a predetermined correcting parameter, and outputs the corrected signal is known. The correcting parameter in this technology is a value set based on at least one of a length of a signal transmission line between the storage device and the system side communicating unit, a wavelength attribute of an input signal, and a storage device attribute concerning the storage device.
Patent Document 1: Japanese Laid-Open Patent Publication No. 2007-53648
Patent Document 2: Japanese Laid-Open Patent Publication No. 2006-42179

As described above, in order to determine a setting parameter for waveform adjustment, since the setting pattern is enormous, it requires lots of man hour to search an optimal setting pattern. Recently, in the high speed transmission channel, the number of setting parameters which are obtained is increased in accordance with the increase in the number of lanes, and the setting parameter is segmentized in accordance with the increases in the transmission speed so that the conditions of the setting patterns are complicated. For these reasons, it is expected that it takes more man-hour to determine the setting parameter as compared with the related art and it is also desired to automatize the search of the optimal setting pattern.

However, as illustrated in FIG. 14, when the setting parameters are set by consoles 400a and 400b for every device 200 and 300, it is difficult to perform the test by interworking of the two devices because the independent consoles 400a and 400b are used. Further, it is difficult to recognize a value of the setting parameter of the device at the other side. Therefore, in the method illustrated in FIG. 14, it is difficult to adjust the timing of changing a parameter between both devices and manage the parameter, which also interrupts an efficient automatic test (evaluation).

Further, in the above-mentioned related technology, the optimal values of the output amplitude or the emphasis of the transmitter are calculated, but it is difficult to calculate the setting value at the receiver side.

In addition, in the above-mentioned another related technology, an optimal value is selected from predetermined correcting parameters, but the optimal value is not actually calculated by repeatedly transmitting/receiving data between devices. Therefore, the optimal value is hardly calculated in various transmission environments.

As described above, in the above-mentioned methods, it is difficult to efficiently test the setting parameter for transmission and reception.

### SUMMARY

According to an aspect of the embodiments, an information processing apparatus includes: a first transmitting device and a second transmitting device which are connected through a communication line. The first transmitting device includes: a controller that generates setting information concerning transmission and reception of data in the first and second transmitting devices and transmits the generated setting information to the second transmitting device; a detector that detects whether an error is included in data which is transmitted from the second transmitting device and received based on the setting information; and a storage unit that stores information on the error detected by the detector. The second transmitting device includes: a setting unit that sets transmission of data to be transmitted to the first transmitting device based on the setting information received from the controller; and a generator that generates data in accordance with the setting by the setting unit to transmit the data to the first transmitting device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a configuration example of an information processing apparatus according to a first embodiment;

FIG. 2 is a view to explain a determining procedure of a setting parameter in the information processing apparatus illustrated in FIG. 1;

FIG. 3 is a view illustrating an example of a testing result which is stored by an error count storage unit illustrated in FIG. 1;

FIG. 4 is a view illustrating a configuration example of a device including a controller illustrated in FIG. 1;

FIG. 5 is a view illustrating data flow in the device illustrated in FIG. 4;

FIG. 6 is a view illustrating a hardware configuration example of each device illustrated in FIG. 1;

FIG. 7 is a flowchart to explain an executing process of a transmission test in the information processing apparatus illustrated in FIG. 1;

FIG. 8 is a view to explain a determining procedure of an optimal setting parameter by a controller according to a second embodiment;

FIG. 9 is a view to explain a determining procedure of an optimal setting parameter by a controller according to the second embodiment;

FIG. 10 is a view to explain a determining procedure of an optimal setting parameter by a controller according to the second embodiment;

FIG. 11 is a view to explain a determining procedure of an optimal setting parameter by a controller according to the second embodiment;

FIG. 12 is a view illustrating an example of a format of a testing result stored by an error count storing unit according to the second embodiment;

FIG. 13 is a flowchart to explain a determining procedure of an optimal setting parameter by a controller according to the second embodiment; and

FIG. 14 is a view to explain an example of a setting parameter determining procedure.

### DESCRIPTION OF EMBODIMENTS

Hereinafter, embodiments will be described with reference to the drawings.

### [1] First Embodiment

### [1-1] Description of Information Processing Apparatus

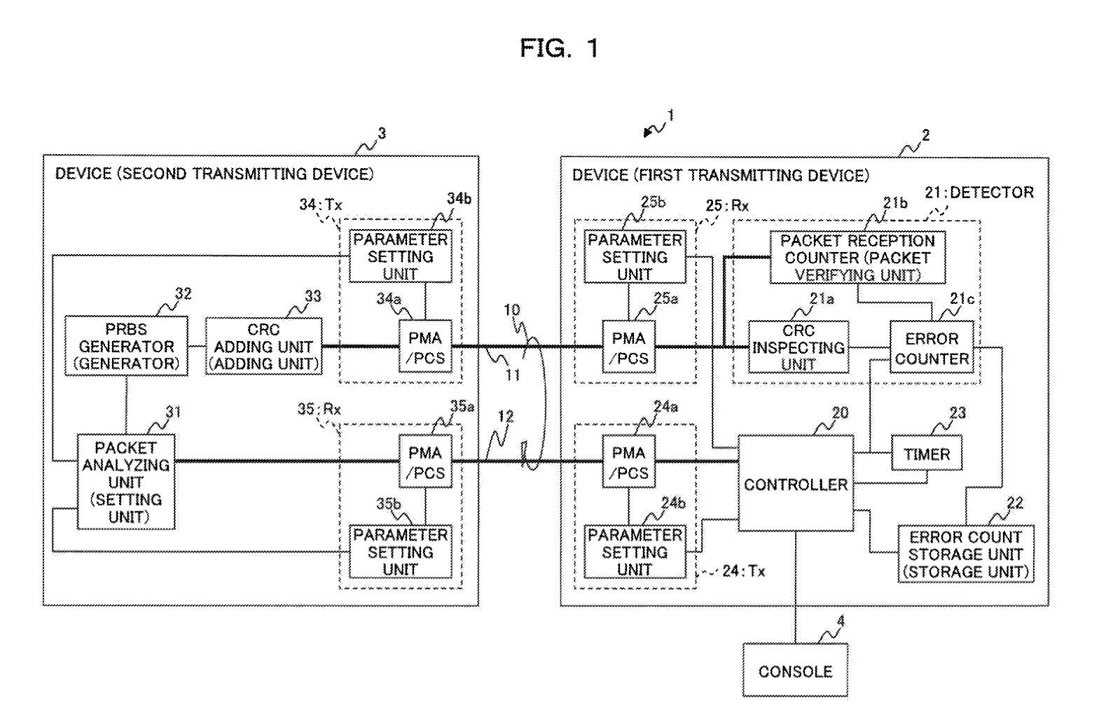

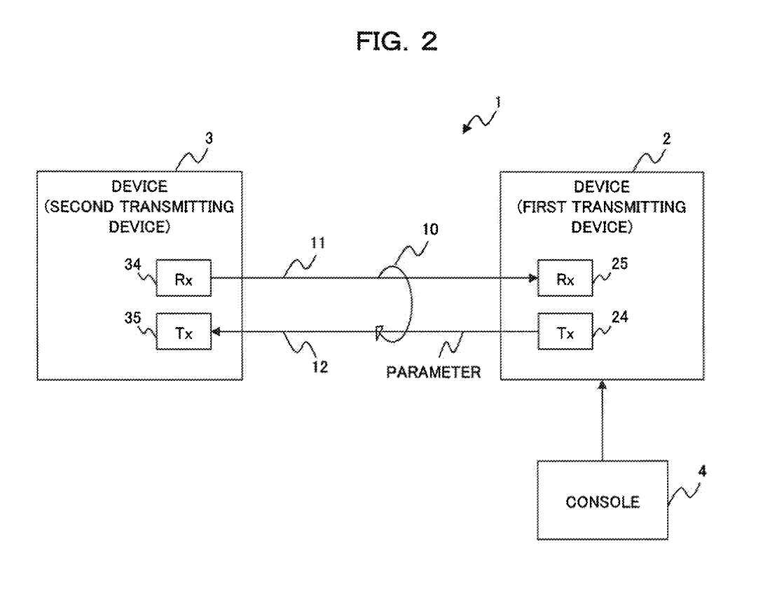

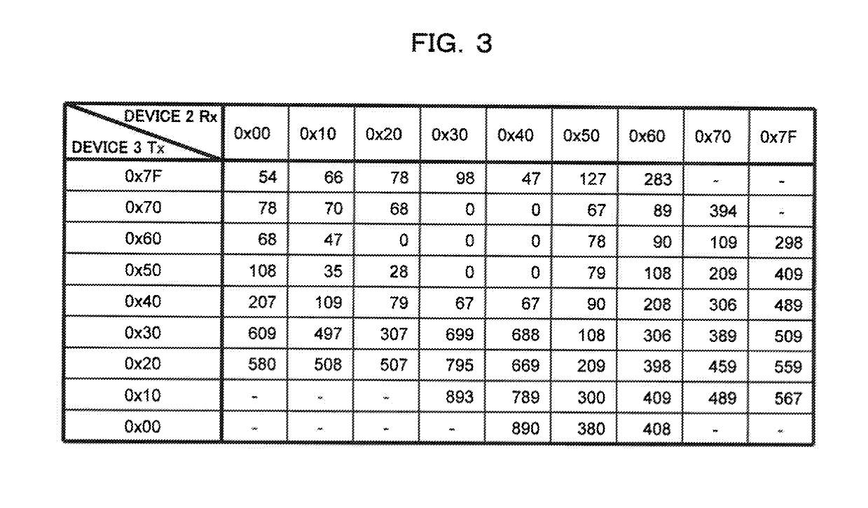

FIG. 1 is a block diagram illustrating a configuration example of an information processing apparatus 1 according to a first embodiment, FIG. 2 is a view to explain a determining procedure of a setting parameter in the information processing apparatus 1 illustrated in FIG. 1, and FIG. 3 is a view illustrating an example of a testing result which is stored by an error count storage unit 22 illustrated in FIG. 1. As illustrated in FIG. 1, the information processing apparatus 1 includes devices 2 and 3 which are connected through a communication line 10 and a console 4. Further, the communication line 10 includes a transmission channel 11 that transmits data from the device 3 to the device 2 and a transmission channel 12 that transmits data from the device 2 to the device 3 in order to perform high speed serial transfer of a signal (data) between the devices 2 and 3.

The device (first transmitting device) 2 includes a Tx 24 and an Rx 25 and the device (second transmitting device) 3 includes a Tx 34 and an Rx 35. The Txs 24 and 34 are transmitters that transmit a signal (data) from the devices 2 and 3 through the transmission channels 12 and 11 and the Rxs 25 and 35 are receivers that receive a signal from the devices 3 and 2 through the transmission channels 11 and 12.

Further, as the devices 2 and 3, there are various devices which are capable of communicating with each other through transmission channels 11 and 12 (communication line 10) such as a lane or a cable. Examples of the devices 2 and 3 include a memory device such as a PCB (printed circuit board) or RAM (random access memory) on which a processor such as a CPU (central processing unit) in the information processing apparatus 1 is mounted or a storage device such as an HDD (hard disk drive). When the above-mentioned devices are used as the devices 2 and 3, as the communication line 10, for example, a transmission channel such as a PCI (peripheral component interconnect) Express or a cable such as an InfiniBand (registered trademark) corresponding to an Ethernet (registered trademark) such as a 10 GbE (Gigabit Ethernet (registered trademark)), or a cable corresponding to an SAS (serial attached SCSI (small computer system interface)) or an SATA (serial advanced technology attachment) may be used. Further, another example of the devices 2 and 3 may include a peripheral device such as a storage device. When this device is used as the devices 2 and 3, as the communication line 10, for example, a cable such as an InfiniBand (registered trademark) corresponding to the Ethernet (registered trademark) or a cable corresponding to a Fibre Channel or a USB (universal serial bus) (for example, USB 3.0 having an emphasis/equalizing function) may be used.

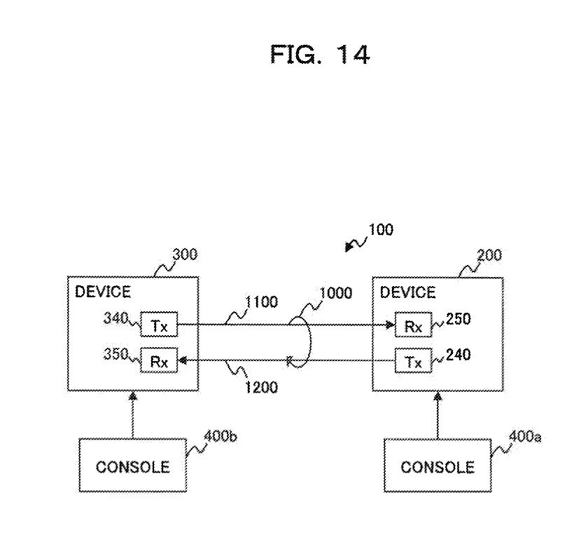

The console 4 is connected to the device 2 and sets initial values of the Tx 24 and the Rx 25 of the device 2 and the Tx 34 and the Rx 35 of the device 3 in the device 2 and controls to start and stop the transmission test. In other words, in the information processing apparatus 1 of the first embodiment, as illustrated in FIG. 14, the consoles 400a and 400b are not provided for every device 200 and 300, but the parameters of both devices 2 and 3 are managed by one console 4 as illustrated in FIG. 2. For example, the device 2, as illustrated in FIG. 2, generates a packet including a setting parameter that is set in the device 3 based on the setting from the console 4 and transmits the packet from the Tx 24 to the device 3 through the transmission channel 12. Accordingly, the device 3 may set the setting parameter based on the packet received by the Rx 35 and transmit testing data from the Tx 34 to the device 2. Therefore, when the setting parameter in the high speed serial interface between the devices, for example, a waveform adjustment parameter is evaluated, parameters of both devices are set by one of the devices so that parameter evaluation is more efficient than the related art and the number of processes for the evaluation is significantly reduced.

Referring back to FIG. 1, the more specific configuration of the information processing apparatus 1 will be described. The device 2 includes a controller 20, a detector 21, an error count storage unit 22, a timer 23, the Tx 24, and the Rx 25.

The controller 20 is connected to the console 4 and generates a setting parameter (setting information) concerning the transmission/reception of the data in the devices 2 and 3 in response to the control from the console 4. Specifically, in the device 2, initial information such as an initial value of a transmitting parameter of the Txs 24 and 34, an initial value of a receiving parameter of the Rxs 25 and 35, an increment of the transmitting parameter and the receiving parameter for changing a parameter is set from the console 4. The controller 20 generates (calculates) the setting parameter based on the set initial information. Further, among the generated setting parameters, the controller 20 sets the transmitting parameter in accordance with the transmission of the data in the Tx 24 and sets the receiving parameter in accordance with the reception of data in the Rx 25. The controller 20 generates a dedicated packet including the setting parameters (transmitting parameter and receiving parameter) and transmits the packet to the device 3.

The detector 21 detects whether the received data (data packet) has an error, the received data is transmitted from the device 3 and is received based on the setting parameter which is set in the Rx 25 by the controller 20. The detector 21 includes a CRC (cyclic redundancy check) inspecting unit 21a, a packet verifying unit 21b, and an error counter 21c.

The CRC inspecting unit 21a determines whether the data packet received from the device 3 includes an error, that is, the data packet corrupts based on the CRC (error detecting code) which is added to the data packet transmitted from the device 3 by a CRC adding unit 33 of the device 3 which will be described below. Here, as an example of a situation in which an error is included in the received data packet, there is a case where a setting parameter (at least one of the transmitting and receiving parameters) which is difficult to transmit data between the devices 2 and 3 is used. For example, when the setting parameter is not matched to the characteristic of the transmission channel 11, the deterioration of data quality or delay may occur in the transmission channel and an error may be included in the received data packet.

When the CRC inspecting unit 21a determines that the error is included in the data packet, the error counter 21c counts the error and sets an error count value in the error count storage unit 22, which will be described below, so as to be associated with the setting parameter in response to the reset instruction, which will be described below, by the controller 20. Further, the error counter 21c may count up the error count associated with the current setting parameter with respect to the error count storage unit 22 whenever the CRC inspecting unit 21a determines that the error is included in the data packet.

When the data packet is not received from the device 3 until the timer 23 to be described below is expired after the setting parameter is transmitted to the device 3 by the controller 20, the packet reception counter (packet verifying unit) 21b maximizes the error count value to be set in the error counter 21c in response to the reset instruction by the controller 20. For example, when a setting parameter (at least one of the transmitting and receiving parameters) which is difficult to transmit the data between the devices 2 and 3 is used, the error count value of the error counter 21c is maintained as “0” even though the data packet is not received by the device 2. Therefore, when the received count number of the data packet during the test is “0” or a predetermined threshold or smaller, that is, the data packet from the device 3 is not recognized, the packet reception counter 21b records the error count value of the error counter 21c, for example, as a total bit “F”.

The error count storage unit (storage unit) 22 stores information on the error detected by the detector 21. For example, the information on the error is a count value of an error when the timer 23 is expired, and the error count storage unit 22, as illustrated in FIG. 3, stores the error count value so as to be associated with the transmitting parameter and the receiving parameter. Further, referential symbols “0x00” to “0x7F” illustrated in FIG. 3 denote setting parameters (receiving and transmitting parameters) of the Rx 25 (horizontal axis) of the device 2 and the Tx 34 (vertical axis) of the device 3, and the intersection of a value of the Rx 25 and a value of the Tx 34 is an error count value. Further, a “-” area of error count value indicates the maximum value set by a packet analyzing unit 31 and a “0” area of the error count value is an optimal setting parameter where no error occurs.

The timer 23 is a timer (counter) that measures a time for a predetermined period and measures a test time. When the counting of a predetermined period by the timer 23 is completed, the controller 20 transmits a stop packet to the device 3. Further, the controller 20 newly generates a setting parameter that changes at least one of the transmitting and receiving parameters and sets the generated setting parameter in the Tx 24 and the Rx 25. Moreover, the controller 20 generates a dedicated packet including the setting parameter and transmits the packet to the device 3. The controller 20 resets the timer 23.

Specifically, when the receiving parameter is a value within a predetermined range, the controller 20 adds or subtracts an increment of the initial information set by the console 4 to or from the receiving parameter to generate the setting parameter. Further, when the receiving parameter is a value exceeding a predetermined range, the controller 20 sets the receiving parameter as an initial value and adds or subtracts an increment of the initial information set by the console 4 to or from the transmitting parameter to generate the setting parameter. As described above, the controller 20 fixes the transmitting parameter to perform the transmission test while the receiving parameter has a value in a predetermined range whenever the timer 23 is expired. Further, when both the transmitting and receiving parameters have values exceeding the predetermined ranges, the controller 20 finishes the transmission test.

Each of the Tx 24 and the Rx 25 includes the PMA/PCS (physical medium attachment/physical coding sublayer) 24a and 25a and parameter setting unit 24b and 25b. The PMA/PCS 24a and 25a serve as a PHY (physical layer), and convert the data between the serial type and the parallel type and negotiate with a connected other communicating party through the transmission channels 11 and 12. In other words, the PMA/PCS 24a parallel to serial converts the data packet which is transmitted through the transmission channel 12 from the Tx 24 and negotiates with the device 3 to transmit the data packet. The PMA/PCS 25a negotiates with the device 3 through the transmission channel 11 and serial to parallel converts the data packet which is received by the Rx 25. The parameter setting unit 24b and 25b set the transmitting and receiving parameters transmitted from the controller 20 in the PMA/PCS 24a and 25a, respectively. Further, a setting value for performing pre-emphasis such as amplitude adjustment of a signal (data) in the Tx 24 is included in the transmitting parameter. A setting value for performing de-emphasis or equalizing such as an amplitude adjustment or phase characteristic (frequency characteristic) adjustment of the signal (data) in the Rx 25 is included in the receiving parameter.

Further, the device 3 includes a packet analyzing unit 31, a PRBS (pseudo-random bit sequence) generator 32, a CRC adding unit 33, the Tx 34, and the Rx 35.

The Tx 34 and the Rx 35 include the PMA/PCSs 34a and 35a and the parameter setting units 34b and 35b, respectively. Further, the PMA/PCSs 34a and 35a and the parameter setting units 34b and 35b have substantially same configuration as the PMA/PCSs 24a and 25a and the parameter setting units 24b and 25b and thus the detailed description thereof will be omitted.

The packet analyzing unit (setting unit) 31 sets the transmission according to the data packet to be transmitted to the device 2 and the reception according to the data packet to be received from the device 2 based on the setting parameter received from the controller 20 of the device 2. Specifically, the packet analyzing unit 31 analyzes a dedicated packet received from the device 2 by the Rx 35 and obtains the setting parameters (transmitting and receiving parameters) and sets the obtained transmitting and receiving parameters in the parameter setting units 34b and 35b. When the received setting parameter is completely set in the Tx 34 and Rx 35, the packet analyzing unit 31 starts the PRBS generator 32. Further, when the stop packet is received from the device 2, the packet analyzing unit 31 stops the PRBS generator 32.

When the PRBS generator (generator) 32 is started in accordance with the setting process of the setting parameter by the packet analyzing unit 31, the PRBS generator 32, for example, sequentially generates random data and transmits the random data to the device 2 before the packet analyzing unit 31 issues the instruction to stop. The CRC adding unit 33 adds the CRC to the data generated by the PRBS generator 32 to be transmitted to the Tx 34.

Further, when a setting parameter which is difficult to transmit the data between the devices 2 and 3 is used, a packet including a setting parameter for the device 3 is not likely to be transmitted from the device 2. Therefore, at least at the time of initially setting the transmission test, it is preferable to set a slow communication, for example, by a protocol in order to surely communicate between the device 2 and the device 3.

As described above, by the information processing apparatus 1 according to the first embodiment, when initial information is set in the device 2 by the console 4, the setting parameters of the devices 2 and 3 are generated by the device 2. The setting parameter of the device 3 is transmitted by the dedicated packet and set in the device 3. Therefore, the manual manipulation by the console 4 starts an automatic transmission test only once and the automatic evaluation is effectively performed, which may significantly reduce the number of evaluating processes.

Further, according to the information processing apparatus 1 according to the first embodiment, one device 2 may set a parameter of the device 3 of the other side and uniform management of the setting parameters including the parameter of the device 3 of the other side in an integrated fashion is allowed in the device 2 (console 4).

In addition, according to the information processing apparatus 1 according to the first embodiment, a count value of the error by the setting parameters (transmitting and receiving parameters) is stored in the error count storage unit 22. Therefore, after completing the transmission test, the setting parameter may be examined (evaluated) based on the result stored in the error count storage unit 22 by an operator such as a designer.

Furthermore, FIG. 1 illustrates an example that the device 2 includes the controller 20, the detector 21, and the error count storage unit 22, the packet from the device 3 is received by the device 2 through the transmission channel 11, and the received packet is inspected. Further, among the setting parameters generated by the controller 20, the transmitting parameter is shared by the Tx 24 of the device 2 and the Tx 34 of the device 3 and the receiving parameter is shared by the Rx 25 of the device 2 and the Rx 35 of the device 3. This is because the communications using a plurality of transmission channels 11 and 12 that configure the communication line 10 are considered to be performed under the same environment.

In other words, when the high speed serial transfer is performed, when one-on-one communication between the device 2 and the device 3 is performed, it is considered that the transmission channels 11 and 12 that connect the device 2 and the device 3 have substantially same characteristics. Therefore, the information processing apparatus 1 according to the first embodiment unifies the transmitting and receiving parameters of the setting parameters by the devices 2 and 3 and performs the transmission test when the data is transmitted from the device 3 to the device 2 through the transmission channel 11 to evaluate an optimal setting parameter for the characteristic of the transmission channel 11. Similarly, when data is transmitted from the device 2 through the transmission channel 12 to the device 3, the information processing apparatus 1 uses the setting parameter obtained by the evaluation as an effective setting parameter. Therefore, the devices 2 and 3 do not have overlapping functions and may have a simple configuration that transmits test data from one device 3 to the other device 2, which may reduce the development and manufacturing cost.

### [1-2] As for Device Including Controller

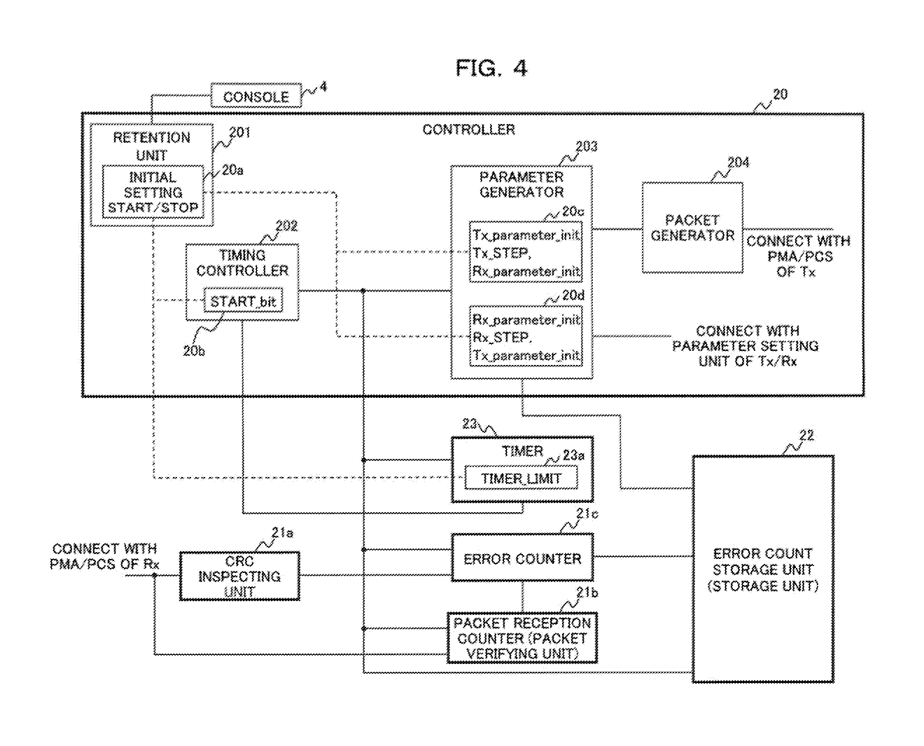

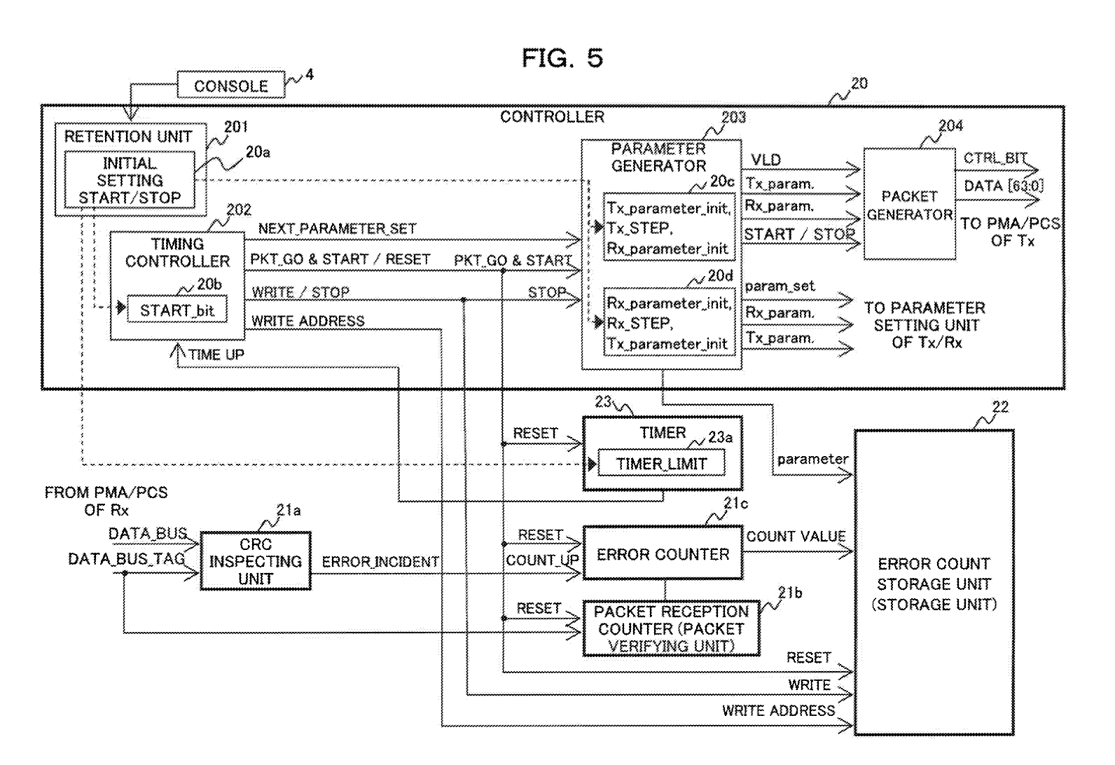

Next, a specific configuration example of the device 2 including the controller 20 will be described with reference to FIGS. 4 and 5. FIG. 4 is a view illustrating a configuration example of the device 2 including the controller 20 illustrated in FIG. 1 and FIG. 5 is a view illustrating data flow in the device 2 illustrated in FIG. 4. Further, in FIGS. 4 and 5, since the same reference numerals as the reference numerals of FIG. 1 denote the same or substantially same configurations illustrated in FIG. 1, the overlapping description will be omitted. Further, in FIGS. 4 and 5, the Tx 24 and Rx 25 are omitted.

As illustrated in FIGS. 4 and 5, the controller 20 includes a retention unit 201, a timing controller 202, a parameter generator 203, and a packet generator 204. The retention unit 201 is connected to the console 4. The retention unit 201 includes a register 20a. The register 20a sets and stores an initial value of the transmitting parameter “Tx_parameter_init”, an increment of the transmitting parameter “Tx_STEP”, an initial value of the receiving parameter “Rx_parameter_init”, an increment of the receiving parameter “Rx_STEP” as initial information (initial setting) from the console 4. Further, the register 20a sets and stores “START/STOP” which indicates the start or stop of the transmission test and “TIMER_LIMIT” which indicates the limit of the test time (predetermined period) from the console 4. These values which are stored in the register 20a of the retention unit 201 are reflected in registers within the timing controller 202, the parameter generator 203, and the timer 23 along the broken line of FIGS. 4 and 5.

The timer 23 includes the register 23a. “TIMER_LIMIT” set in the register 20a is reflected to the register 23a. When the measurement of the test time exceeds a value set in “TIMER_LIMIT”, the timer 23 issues a “TIME UP” command indicating that the time is up to the timing controller 202. Further, the timer 23 resets the measurement of the test time by the reset instruction which will be described below from the timing controller 202 and measures the test time again.

The timing controller 202 generates the setting parameter, issues the transmitting of the packet to the device 3 and the starting (resuming) instruction, resetting instruction of the transmission test, writing instruction to the error count storage unit 22, and a writing address. The timing controller 202 includes a register 20b. In the register 20b, “START/STOP” set in the register 20a is reflected as a “START_bit”. When a value of “START_bit” of the register 20b is a value indicating “START”, the timing controller 202 performs the following process.

The timing controller 202 issues commands (i) and (ii) and starts (resumes) the transmission test.

(i) a “NEXT-PARAMETER_SET” command indicating the instruction to generate the following transmitting and receiving parameters is issued to the parameter generator 203.

(ii) a “PKT_GO & START” command indicating the instruction to generate and transmit the packet to the device 3 is issued to the packet generator 204 through the parameter generator 203.

Further, when the timing controller 202 receives the “TIME UP” command from the timer 23, the timing controller 202 issues commands (iii) to (v) and stops (temporally stops) the transmission test.

(iii) the timing controller 202 issues a “STOP” command to the packet generator 204 through the parameter generator 203.

(iv) the timing controller 202 issues a “RESET” command indicating the reset instruction to the packet reception counter 21b, the error counter 21c and the timer 23.

(v) the timing controller 202 issues a “WRITE” command instructing to write the error count value and a “WRITE ADDRESS” indicating a writing address to the error count storage unit 22.

Further, when the timing controller 202 issues the commands (iii) to (v), the timing controller 202 issues the commands (i) and (ii) in order to perform the transmission test by the next transmitting and receiving parameters. As described above, the timing controller 202 repeatedly issues the commands (i) to (v) to control the timing of the transmission test in the controller 20.

The parameter generator 203 generates the setting parameters of the devices 2 and 3, outputs “parameter” which indicates a current setting parameter to the error counter 21c in accordance with the “STOP” command from the timing controller 202 and includes registers 20c and 20d. In the register 20c, “Tx_parameter_init”, “Tx_STEP”, and “Rx_parameter_init” set in the register 20a are reflected and in the register 20d, “Rx_parameter_init”, “Rx_STEP”, and “Tx_parameter_init” set in the register 20a are reflected. When the parameter generator 203 receives the instruction to generate the next transmitting and receiving parameters from the timing controller 202, the parameter generator 203 generates the setting parameter that is set in the device 3 based on the value set in the register 20c and the setting parameter that is set in the device 2 based on the value set in the register 20d. Further, when the parameter generator 203 generates an initial setting parameter after starting the transmission test, for example, the parameter generator 203 generates initial values of the transmitting and receiving parameters as setting parameters.

Further, the parameter generator 203 issues the generated receiving parameter “RX_param.” and the transmitting parameter “TX_param.” together with the “param_set” command which is instruction to set a parameter to the parameter setting units 24b and 25b of the Tx 24 and Rx 25 of the device 2. Further, the parameter generator 203 issues “RX_param.” and “TX_param.” together with the “VLD” command concerning the control of the packet generation and “PKT_GO & START” command issued from the timing controller 202 to the packet generator 204. Further, the resisters 20c and 20d may be commonly used and a value overlapping in the registers 20c and 20d may be omitted. Further, the parameter generator 203 may store the generated setting parameters to generate next setting parameters.

The specific procedure of generating the setting parameters by the parameter generator 203 will be described using an example that all of initial values of “RX_param.” and “TX_param.” are “0x00” and the increment is “0x10” as illustrated in FIG. 3. The parameter generator 203 generates the setting parameters, for example, in which the “TX_param.” is fixed to “0x00” and the “RX_param.” is changed from “0x00” to “0x7F” for every increment whenever the instruction to generate the next transmitting and receiving parameters is received. When the “RX_param.” is “0x7F” (maximum value), upon receipt of the parameter generator 203 receives the instruction to generate next transmitting and receiving parameters, the parameter generator 203 generates a setting parameter of “RX_param.” which is changed into “0x00” and “TX_param.” which is increased into “0x10” by one increment. Thereafter, the parameter generator 203 generates a setting parameter in which the “TX_param.” is fixed to “0x10”, and the “RX_param.” is changed from “0x00” to “0x7F” for every increment whenever the instruction to generate the next transmitting and receiving parameters is received. When all “RX_param.” and “TX_param.” reach the maximum values, the controller 20 finishes the transmission test. Further, when the initial value of the setting parameter is a maximum value such as “0x7F”, the parameter generator 203 may decrease the initial value of the setting parameter for every increment to generate a setting parameter.

As described above, the parameter generator 203 fixes one of parameters (for example, “TX_param.”) and changes the other parameter (for example, “RX_param.”) and when the other parameter reaches the maximum value, the parameter generator 203 changes the one parameter by an increment and changes the other parameter again. Therefore, the parameter generator 203 may generate setting parameters for all combinations of “RX_param.” and “TX_param.” to implement the transmission test without leakage. Further, the maximum values (or minimum values) of “RX_param.” and “TX_param.” may be set as the initial setting by the console 4 or the controller 20 may store the maximum values (or minimum values) of the Tx 24 (and 34) and the Rx 25 (and 35) in advance.

The packet generator 204 generates a dedicated packet, for example, including “CTRL_BIT” and “DATA [63:0]” based on “VLD”, “RX_param.” and “TX_param.” issued from the parameter generator 203 in accordance with “PKT_GO & START” command issued from the timing controller 202 and issues the dedicated packet to the PMA/PCS 24a of the Tx 24 to be transmitted to the device 3. Further, the packet generator 204 generates a stop packet that stops to generate the random data by the PRBS generator 32 in accordance with the “STOP” command issued from the timing controller 202 and issues the stop packet to the PMA/PCS 24a of the Tx 24 to be transmitted to the device 3.

The CRC inspecting unit 21a is connected to the PMA/PCS 25a through a “DATA_BUS” which is a data bus and a “DATA_BUS_TAG” which is a tag of the data bus and inspects the CRC which is included in the packet from the packet received through the “DATA_BUS” and “DATA_BUS_TAG”. Further, when an error is detected from the received packet, the CRC inspecting unit 21a issues an “ERROR_INCIDENT” command indicating the detection of an error to the error counter 21c.

The packet reception counter 21b counts the number of received packets through the “DATA_BUS_TAG” and sets the maximum value of the error count in the error counter 21c when the counted number of received data packet is “0”, or equal to or smaller than a predetermined threshold in accordance with the resetting instruction from the timing controller 202.

The error counter 21c receives the “ERROR_INCIDENT” from the CRC inspecting unit 21a as “COUNT_UP” indicating count-up and counts up the error count whenever the “COUNT_UP” is received. Further, the error counter 21c outputs the error count value “COUNT VALUE” to the error count storage unit 22 in accordance with the resetting instruction from the timing controller 202 and resets its own error count value.

The error count storage unit 22 associates the “parameter” from the parameter generator 203 with the “COUNT VALUE” from the error counter 21c in accordance with the resetting instruction and “WRITE” command from the timing controller 202 and writes the “parameter” and the “COUNT VALUE” in the “WRITE ADDRESS”. Accordingly, the error count storage unit 22 may store the error count value “COUNT VALUE” which is a testing result by the “WRITE ADDRESS” in accordance with the “parameter”.

Further, when the operator quits the automatic evaluation in the middle, off (“STOP”) is set in the “START/STOP” of the register 20a of the retention unit 201 by the console 4. Accordingly, in the register 20b of the timing controller 202, off (“STOP”) is reflected into “START_bit” and the timing controller 202 issues the stop packet for the device 3 to the packet generator 204 as the “START_bit” is off. The device 3 analyzes the stop packet, stops to generate the random data by the PRBS generator 32 and stops to transmit the data packet to the device 2.

In addition, functions as the above-mentioned devices 2 and 3 may be implemented by providing, for example, a PLC (programmable logic controller) or a sequencer which serves as at least one of the devices 2 and 3 in an LSI (large scale integration) such as a CPU or a control circuit of a memory device or an HDD which is a target of the transmission test. Therefore, without; newly preparing an additional device and accompanying the cost-up of the device, the functions as the devices 2 and 3 may be implemented.

Further, when a device which is a target of the transmission test has a function as one of the devices 2 and 3, a function as the device 2 or 3 may be complementarily included in the device of the other side that performs the transmission test. In addition, when high speed serial transmission is performed between multiple devices by one-to-many or many-to-many connection, the devices may include a plurality of configurations of at least one of the devices 2 and 3 such that respective devices are connected with other devices which are serially connected one to one. In this case, in order for each device to provide the Tx and Rx for every communication line 10, when the test is not performed for the simultaneous multiple connections by one device, the devices may commonly have all or some of the functions as the controller 20, the detector 21, the error count storage unit 22, the timer 23, the packet analyzing unit 31, the PRBS generator 32, and the CRC adding unit 33.

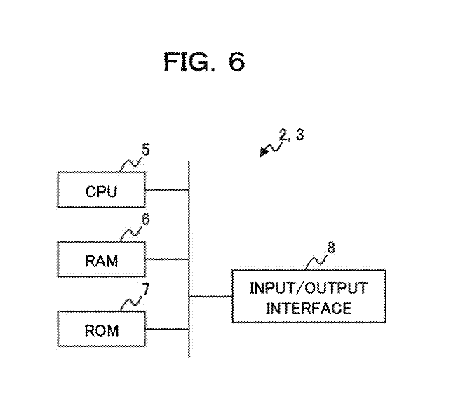

Furthermore, the functions as the above-mentioned devices 2 and 3 may be implemented by executing a program which is stored in the RAM by the CPU. FIG. 6 is a view illustrating a hardware configuration example of each device 2 and 3 illustrated in FIG. 1. As illustrated in FIG. 6, each of the devices 2 and 3 or the information processing apparatus 1 may include a CPU 5, a RAM 6, a ROM 7, and an input/output interface 8. The CPU 5 is a processing device (processor) that performs various control or operations. The CPU 5 executes a program (testing program) stored in the ROM 7 to implement the functions of the controller 20, the detector 21, the timer 23, the parameter setting units 24b and 25b in the device 2 and the packet analyzing unit 31, the PRBS generator 32, the CRC adding unit 33, and the parameter setting units 34b and 35b in the device 3.

The RAM 6 is a storage device that temporally stores various data or programs and is used for temporally storing or expanding data or program when the CPU 5 executes the program. Further, the RAM 6 may be used as the error count storage unit 22 or the registers 20a to 20d in the controller 20 illustrated in FIGS. 4 and 5 or the register 23a in the timer 23. The ROM 7 stores the testing program that allows the CPU 5 to execute the function as the device 2 or the device 3, or the information processing apparatus 1. The input/output interface 8 functions as the Tx 24 or the Rx 25 (PMA/PCS 24a and 25a) in the device 2 or the Tx 34 or the Rx 35 (PMA/PCS 34a and 35a) in the device 3 and is connected to the other devices through the communication line 10 which is not illustrated.

### [1-3] Operational Example of Information Processing Apparatus

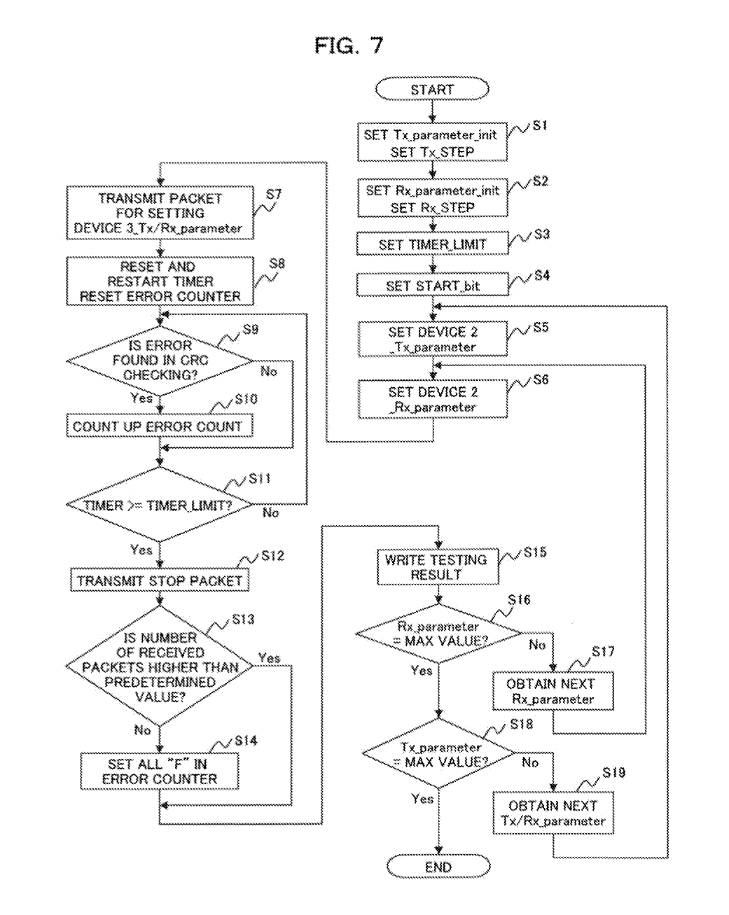

Next, an operational example of the information processing apparatus 1 configured as described above will be described with reference to FIG. 7. FIG. 7 is a flowchart to explain an executing process of a transmission test in the information processing apparatus 1 illustrated in FIG. 1.

First, initial values of the transmitting and receiving parameters of the devices 2 and 3 and variables (increment) that automatically change the setting parameters are input to the device 2 by the console 4 which is connected to the device 2 (steps S1 and 32). Further, the console 4 inputs a “TIMER_LIMIT” that indicates a test time in a set of setting parameters to the device 2 (step S3). As the console 4 sets “START” for the device 2, the start bit “START_bit” is on (step S4) and the transmission test starts.

When the start bit is on, the controller 20 of the device 2 generates the setting parameters and sets the setting parameter in the own device 2 (steps S5 and S6) and the Tx 25 transmits a dedicated packet including the setting parameters to the device 3 (step S7). Continuously, the controller 20 of the device 2 resets and restarts the timer 23 and resets the error count value of the error counter 21c (step S8). Further, in the device 3, when the dedicated packet for the setting parameter is received, the packet analyzing unit 31 analyzes the received packet and the transmitting parameter and receiving parameter are set in the Tx 34 and Rx 35. Furthermore, the PRBS generator 32 is started and the transmission of the random data to the device 2 is started.

In the device 2, the CRC inspecting unit 21a performs the CRC check of the data packet which is sent from the device 3 and determines whether an error is included (step S9). When the CRC error is not detected (No route in step S9), the procedure proceeds to step S11. In contrast, when the CRC error is detected (Yes route in step S9), error count is up in the error counter 21c (step S10) and the procedure proceeds to step S11.

In step S11, it is determined whether the test time measured by the timer 23 is a value of “TIMER_LIMIT” or higher. When the test time measured is lower than the value of “TIMER_LIMIT” (No route in step S11), the procedure proceeds to step S9. In contrast, when the count of the test time is a value of “TIMER_LIMIT” or higher (Yes route in step S11), that is, when it is a set test time, the stop packet is transmitted to the device 3 by the controller 20 (step S12). In the device 3, after receiving the stop packet, the transmission of the random data from the PRBS generator 32 is stopped.

Further, the packet reception counter 21b determines whether the received packet number is a predetermined number (“0” or a predetermined threshold) or higher (step S13). When the received packet number is a predetermined number or higher (Yes route in step S13), the procedure proceeds to step S15. In contrast, when the received packet number is lower than a predetermined number (No route in step S13), the maximum value of the error count value (for example, all bits “F”) is set in the error counter 21c by the packet reception counter 21b (step S14) and the procedure proceeds to step S15. In step S15, as a testing result, the setting parameter at the time and the error count value stored in the error counter 21c are written in the error count storage unit 22 by the controller 20.

When the testing result is completely written, the controller 20 of the device 2 determines whether the receiving parameter is the maximum value (step S16). When the receiving parameter is not the maximum value (No route in step S16), a next receiving parameter obtained by changing the receiving parameter by the increment is calculated (generated) (step S17) and the procedure proceeds to step S6. In other words, the controller 20 sets the receiving parameter of the device 2 (step S6) while fixing the transmitting parameter and the Tx 24 issues a dedicated packet for resetting the receiving parameter of the device 3 (step S7) and the automatic evaluation is continuously performed by the transmission test.

Further, in step S16, when the receiving parameter is the maximum value (Yes route in step S16), that is, when one round of setting of the receiving parameter is completed, the controller 20 of the device 2 determines whether the transmitting parameter is the maximum value (step S18). When the transmitting parameter is not the maximum value (No route in step S18), a next transmitting parameter obtained by changing the transmitting parameter by the increment is calculated (generated) (step S19) and the procedure proceeds to step S5. Further, an initial value is set for the receiving parameter.

The above-mentioned operations are repeated by the devices 2 and 3, and in step S18, when the transmitting parameter is the maximum value (Yes route in step S18), that is, all the combinations of the setting parameters are completed, the test is completed.

Further, a start bit which is set in the controller 20 of the device 2 is set to be off (“STOP”) by the manipulation from the console 4 during the transmission test, the stop packet is issued from the device 2 to the device 3 and the test is completed.

As described above, according to the information processing apparatus 1 of the first embodiment, the setting parameter in accordance with the transmission/reception of the data in the devices 2 and 3 is generated by the controller 20 of the device 2 and the generated setting parameter is transmitted to the device 3. Further, the transmission in accordance with the data to be transmitted to the device 2 is set based on the transmitted setting parameter by the packet analyzing unit 31 of the device 3 and the data is generated by the PRBS generator 32 and then transmitted to the device 2. In the device 2, the detector 21 detects whether the data transmitted from the device 3 and received based on the setting parameter includes an error and information on the error detected by the detector 21 is stored in the error count storage unit 22.

Therefore, as illustrated in FIG. 14, the setting parameters of the devices 200 and 300 do not need to be manually changed from the console 400 by the operator and thus the test for obtaining the setting parameters in accordance with the transmission/reception of the data between the devices 2 and 3 which are connected to each other through the communication line 10 may be effectively performed. Accordingly, for example, it is possible to significantly reduce a man hour in the evaluation of the trial production of the devices 2 and 3.

Further, in accordance with the measurement of a predetermined period of time by the timer 23, in order to generate the setting parameter every time, an error for every setting parameter may be detected from data received for a constant test time and the information on the error may be precisely collected.

In addition, a CRC (error detecting information) is added to the data transmitted from the device 3 by the CRC adding unit 33. Further, based on the CRC added to the data received from the device 3, whether the received data includes an error is checked and then the error is counted by the detector 21. Therefore, with a simple configuration, it is possible to obtain a high precision testing result to determine whether the setting parameter is proper.

Further, when the data is not received from the data until the timer 23 is expired after transmitting the setting parameter to the device 3 by the controller 20, the maximum count value is set in the error count storage unit 22 by the detector 21. Therefore, even though the setting parameter is not proper so that the data is not received from the device 3, it is possible to prevent a preferable testing result from being represented as the error count value becomes “0”, which increases the precision of the test.

### [1-4] First Modification of First Embodiment

In the above-described first embodiment, it is described that the controller 20 generates the transmitting and receiving parameters of the devices 2 and 3 as setting parameters (setting information) and performs the transmission test. However, the invention is not limited thereto, but other transmission conditions may be included in the setting parameters. For example, the setting parameter may further include a transmission clock of the data transmitted from the Txs 24 and 34 and the data received by the Rxs 25 and 35 or voltages (applied voltages) in the Txs 24 and 34 and the Rxs 25 and 35.

When the setting parameter includes the transmitting and receiving parameters, the transmission clock, and the voltage, the controller 20 may generate the setting parameter in the transmission test by any one of the following methods (a) to (c).

(a) The transmission clock and the voltage are fixed to predetermined values, the transmission test (see FIG. 7) described in the first embodiment is performed, and for example, the optimal transmitting parameter and receiving parameter are evaluated and determined by the operator. Thereafter, the determined transmitting parameter and receiving parameter are set in the Txs 24 and 34 and the Rxs 25 and 35, respectively. The transmitting parameter generated by the controller 20 in the transmission test described in the first embodiment is substituted with the transmission clock and the receiving parameter is substituted with the voltage and the transmission test (see FIG. 7) is performed again. In other words, the transmission test illustrated in FIG. 7 is performed for the transmitting parameter and the receiving parameter and then performed for the transmission clock and the voltage.

(b) A plurality of configurations of the devices 2 and 3 illustrated in FIG. 1 and a plurality of communication lines 10 are prepared. In each lane, for example, the transmission clock or the voltage are set so as to be shifted by an increment and then the transmission tests (see FIG. 7) described in the first embodiment are simultaneously performed in each lane.

(c) In the transmission test illustrated in FIG. 7, between step S6 and step S7, a step of setting the transmission clock and a step of setting the voltage are provided. Further, between step S15 and step S16, similarly to step S16 and step S17, a step by the voltage and a step by the transmission clock are provided. In other words, steps of generating and setting the setting parameter in the transmission test illustrated in FIG. 7 are changed from a double loop to a quadruple loop.

As described above, according to the first modification of the first embodiment, in addition to the achieving of the same effect as the information processing apparatus 1 of the first embodiment, a test may be performed in a state where a margin is applied to each of the setting parameters and a test may be performed with a higher precision. Further, in addition to the transmission clock or the voltage, various environmental variations which may affect the transmission characteristic of the communication line 10 may be added to the setting parameters.

### [1-5] Second Modification of First Embodiment

Further, in the first embodiment, it is described that the setting parameters of the device 2 and the setting parameters of the device 3 are the same. However, the invention is not limited thereto, but the setting parameter of the device 2 and the setting parameter of the device 3 may be different from each other. Even in this case, for example, any one of the methods (a) to (c) of the first modification may be used to perform the transmission test. When the method (a) is used, for example, the transmission test using the transmission channel 11 and the determination of the optimal setting parameter are performed for a set of the transmitting parameter of the device 3 and the receiving parameter of the device 2 and then the transmission test using the transmission channel 12 is performed for a set of the transmitting parameter of the device 2 and the receiving parameter of the device 3.

As described above, according to the second modification of the first embodiment, in addition to the achieving of the same effect as the information processing apparatus 1 of the first embodiment, a high precision test may be performed in consideration of the characteristics for every transmission channel 11 and 12.

### [1-6] Third Modification of First Embodiment

In the above-described first embodiment and each of the modifications, it is described that the device 3 transmits the random data pattern by the PRBS generator 32. However, the invention is not limited thereto. For example, the device 3 may include a circuit that generates an arbitrary test pattern instead of the PRBS generator 32 or include a memory that stores an arbitrary test pattern and a circuit that uses the test pattern read out from the memory.

As described above, according to the third modification of the first embodiment, the same effect as the information processing apparatus 1 of the first embodiment may be obtained. Further, a test may be performed for a specific pattern in which art error is easily generated by the influence of the characteristics of the transmission channel like the pattern in which the bits are alternately inverted so that a high precision test may be performed.

### [2] Second Embodiment

### [2-1] As for Controller

In the first embodiment, it is described that the testing result which is stored in the error count storage unit 22 is used to evaluate an optimal setting parameter by the operator after completing the transmission test. However, as described below, the evaluation of the setting parameter based on the testing result, and determination and setting of the optimal setting parameter set for the Txs 24 and 34 and the Rxs 25 and 35 may be performed by the controller 20. In other words, the controller 20 determines the setting value (optimal setting parameter) in accordance with the transmission/reception of data through the communication line 10 between the devices 2 and 3 and sets the setting value in the device 2 and transmits the determined setting value to the device 3 to be set based on the information on the error stored by the error count storage unit 22.

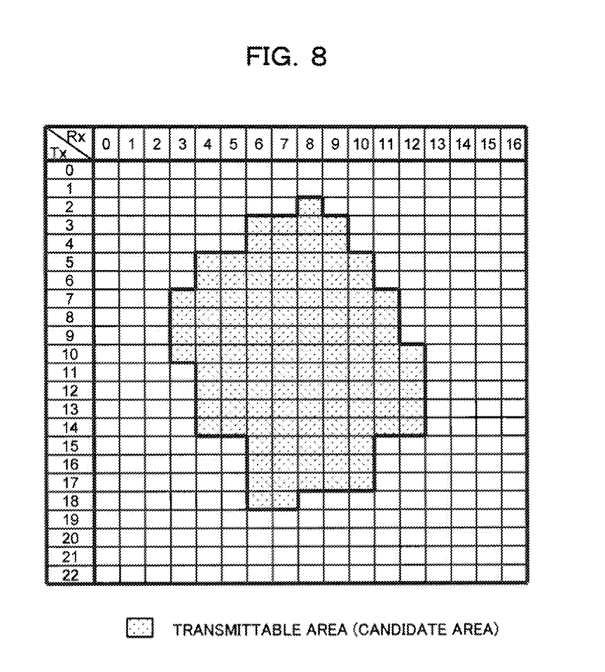

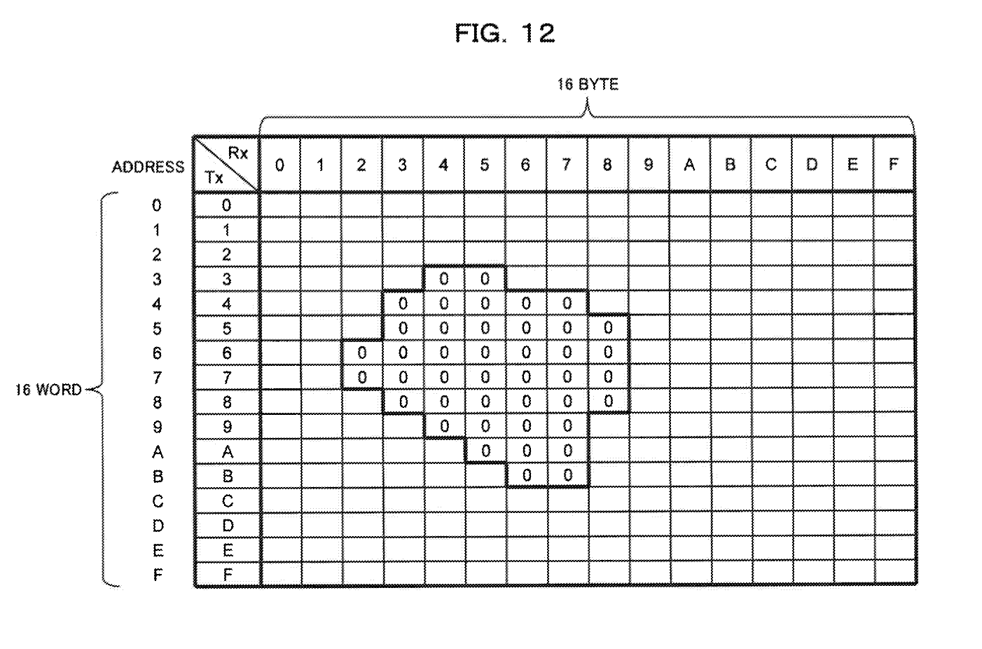

Hereinafter, an example of the testing result which is stored by the error count storage unit 22 and the processing of the controller 20 will be described with reference to FIGS. 8 to 12. FIGS. 8 to 11 are views to explain a determining procedure of an optimal setting parameter by the controller 20 according to a second embodiment and FIG. 12 is a view illustrating an example of a format of a testing result stored by the error count storage unit 22.

As described above, the error count storage unit 22 stores the information on the error (error count value) which is detected by the CRC inspecting unit 21a and counted by the error counter 21c so as to be associated with the transmitting and receiving parameters. Further, in the example illustrated in FIGS. 8 to 11, the receiving parameters (hereinafter, referred to as Rx) of the Rx 25 (horizontal axis) of the device 2 are denoted by “0” to “16” and the transmitting parameters (hereinafter, referred to as Tx) of the Tx 34 (vertical axis) of the device 3 are denoted by “0” to “22”.

When the transmission test is completed, the controller 20 obtains a transmittable area (candidate area) of the combination of the transmitting parameters and the receiving parameters from the information on the error stored by the error count storage unit 22. The transmittable area refers to an area of the combination of the transmitting parameters and the receiving parameters, for example, where a count value of the error is “0” or lower than a predetermined threshold so that no error occurs or the error rarely occurs. Further, as the predetermined threshold which is used in this embodiment, for example, a count number of the error which is acceptable (transmittable) at the time of transmission is set in advance by the operator. The controller 20 obtains the transmittable area from the information on the error stored by the error count storage unit 22 and determines an optimal setting parameter from this area (candidate area). Further, in the example illustrated in FIG. 8, a hatched area enclosed by the heavy line is a transmittable area.

Continuously, the controller 20 obtains the center of every transmitting parameter in the receiving parameter direction in the transmittable area as a receiving parameter candidate area and obtains the center of every receiving parameter in the transmitting parameter direction in the transmittable area as a transmitting parameter candidate area.

Specifically, the controller 20 obtains sequentially receiving parameters for every transmitting parameter of the transmittable area. The controller 20 obtains a center of a receiving parameter of the transmittable area sequentially obtained for every transmitting parameter as a receiving parameter candidate area. The receiving parameter candidate area is an area in which the transmittable area is narrowed in the receiving parameter direction and the controller 20 determines the optimal setting parameter from the receiving parameter candidate area.

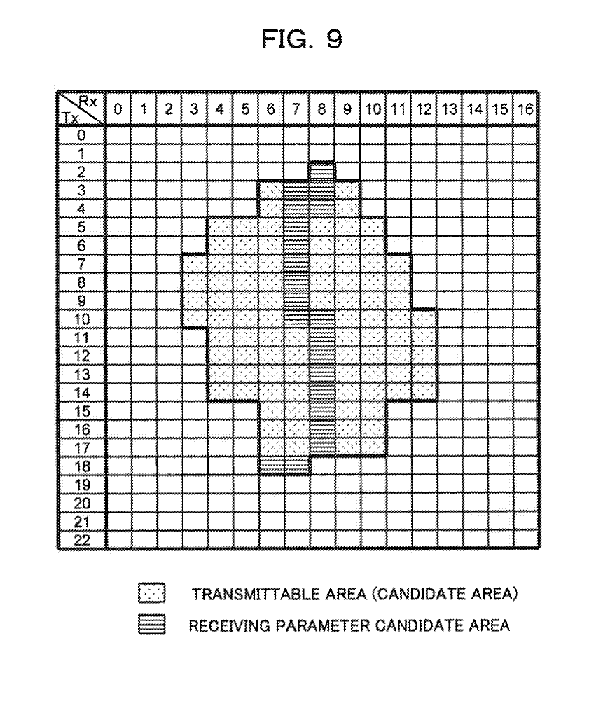

For example, the controller 20, as illustrated in FIG. 9, obtains Rx “8” for Tx “2”, Rxs “6” to “9” for Tx “3”, . . . , Rxs “3” to “12” for Tx “10” . . . , and Rxs “6” to “7” for Tx “18”. Further, the controller 20 selects Rx “8” for Tx “2”, Rxs “7” to “8” for Tx “3”, . . . , Rxs “7” to “8” for Tx “10”, . . . , and Rxs “6” to “7” for Tx “18” as centers of Rxs and obtains (stores) a plurality of combinations of the selected Txs and Rxs as receiving parameter candidate areas. In the example illustrated in FIG. 9, an area represented by the horizontal lines is a receiving parameter candidate area.

Similarly, the controller 20 obtains sequentially transmitting parameters for every receiving parameter of the transmittable area. The controller 20 obtains a center of a transmitting parameter of transmittable area sequentially obtained for every receiving parameter as a transmitting parameter candidate area. The transmitting parameter candidate area is an area in which the transmittable area is narrowed in the transmitting parameter direction and the controller 20 determines the optimal setting parameter from the transmitting parameter candidate area.

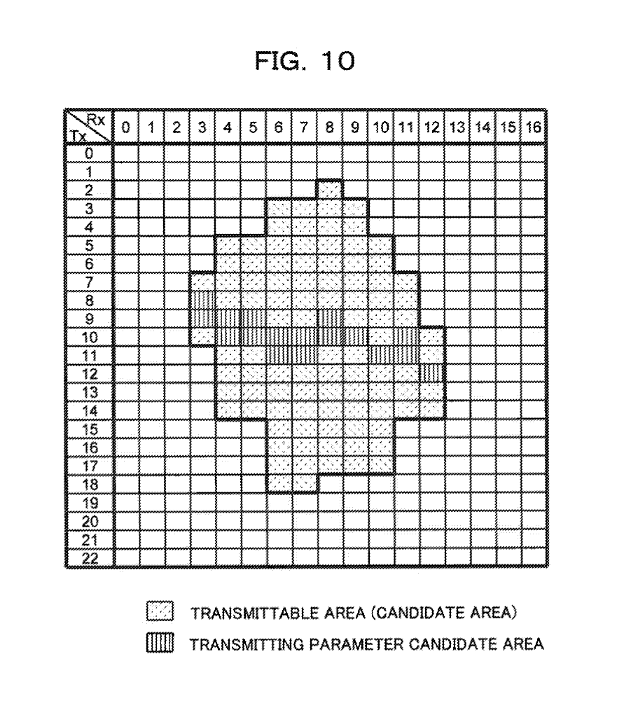

For example, the controller 20, as illustrated in FIG. 10, obtains Txs “7” to “10” for Rx “3”, Txs “5” to “14” for Rx “4”, . . . , Txs “3” to “18” for Rx “7”, . . . , and Txs “10” to “14” for Rx “12”. Further, the controller 20 selects Txs “8” to “9” for Rx “3”, Txs “9” to “10” for Rx “4”, . . . , Txs “10” to “11” for Rx “7”, . . . , and Tx “12” for Rx “12” as centers of Txs and obtains (stores) a plurality of combinations of the selected Txs and Rxs as transmitting parameter candidate areas. In the example illustrated in FIG. 10, an area represented by the vertical lines is a transmitting parameter candidate area.

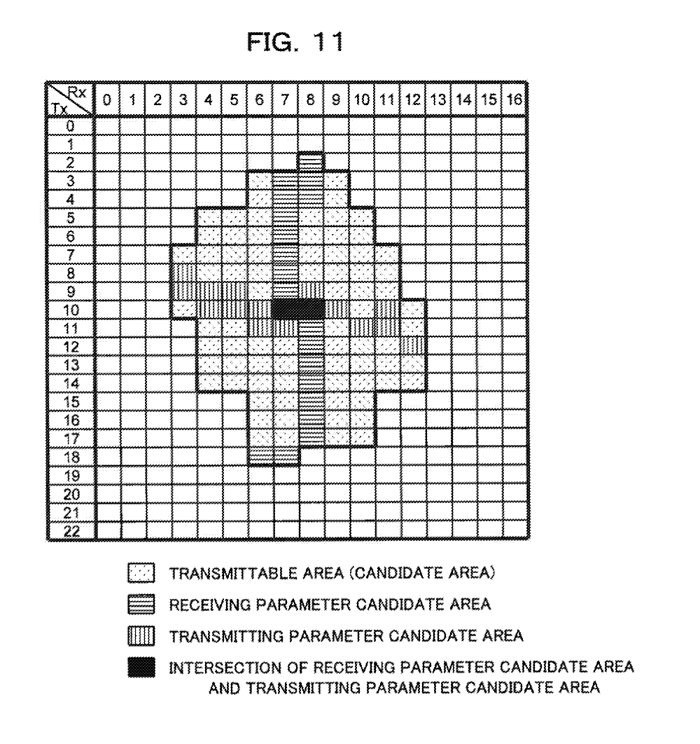

Further, the controller 20 determines the optimal setting parameter (setting value) based on the combinations of the receiving parameters and the transmitting parameters at the intersections of the receiving parameter candidate areas and the transmitting parameter candidate areas. Specifically, the controller 20, as illustrated in FIG. 11, overlaps the receiving parameter candidate area obtained in the example illustrated in FIG. 9 and the transmitting parameter candidate area obtained in the example illustrated in FIG. 10. The controller 20 determines the overlapping point (area) of the receiving parameter candidate area and the transmitting parameter candidate area, that is, an area where Tx is “10” and Rx is “7” or “8” as the optimal setting parameter (setting value). Further, in the example illustrated in FIG. 11, the completely filled area is the intersection of the receiving parameter candidate area and the transmitting parameter candidate area.

As described above, the controller 20 obtains a point at which a more margin is allowed from the range of the transmittable area, that is, a centroid of the area to determine the optimal setting parameter. Further, as illustrated in FIG. 11, when multiple centers of the transmittable area are obtained, the controller 20 selects any one of them to be set as the setting value. Alternatively, when the transmitting and receiving parameters are more minutely set, a value in the middle (in the example of FIG. 11, Tx “10” and Rx “7.5”) is determined as the setting value.

Further, the controller 20 sets the determined optimal setting parameter in the parameter setting units 24b and 25b of the Tx 24 and the Rx 25 as a setting value and transmits the determined optimal setting parameter to the device 3 so as to be included in the packet to be set in the parameter setting units 34b and 35b of the Tx 34 and the Rx 35.

In addition, for the purpose of the description, in FIGS. 8 to 11, the range of the Rx is “0” to “16” and the range of Tx is “0” to “22”. However, the format of the testing result stored by the error count storage unit 22 may be determined depending on the setting parameters of the Txs 24 and 34 and the Rxs 25 and 35. For example, when both the transmitting parameter and the receiving parameter are 4 bits, that is, when the combinations of the setting parameters are 256 (=16×16) patterns, the format of the testing result is preferably a format illustrated in FIG. 12.

In other words, in the error count storage unit 22 (for example, RAM), the error count value is represented by one byte and an error count value of each of the receiving parameters in one transmitting parameter is set in one word. In other words, all combinations of the setting parameters are set in an area of 16 word×16 byte of the error count storage unit 22. Therefore, as illustrated in FIGS. 4 and 5, the “WRITE ADDRESS” designated by the timing controller 202 may be easily associated with the “parameter” from the parameter generator 203 and the testing result may be easily stored and managed.

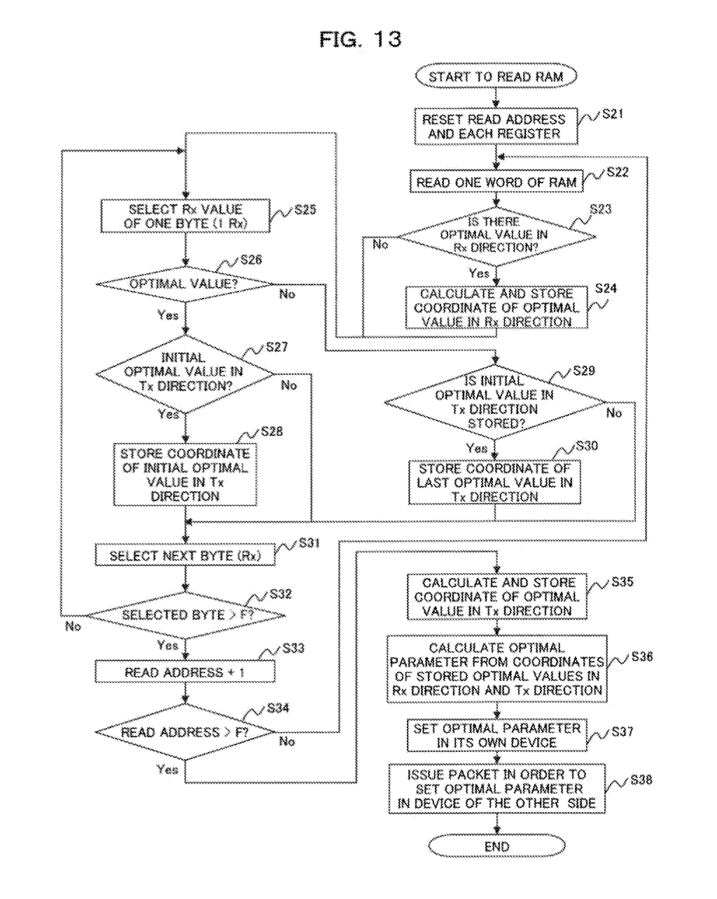

Next, the operational example of the controller 20 as described above will be described with reference to FIG. 13. FIG. 13 is a flowchart to explain a determining procedure of the optimal setting parameter by the controller 20 according to the second embodiment. Hereinafter, it is described that the error count storage unit 22 stores the information on the error in accordance with the format of the testing result illustrated in FIG. 12. Further, in the flowchart illustrated in FIG. 13, the receiving parameter candidate area and the transmitting parameter candidate area described with reference to FIGS. 9 and 10 are obtained together by the inspection for every word of the error count storage unit 22.

When the transmission test illustrated in FIG. 7 is completed, the read address that reads out the data from the error count storage unit 22 and the registers in the controller 20 are reset by the controller 20 (step S21) and data for one word is read out from the error count storage unit 22 (step S22). Further, the controller 20 determines whether there is an optimal value in the Rx direction for the read data (step S23). When there is an optimal value (Yes route in step S23), a coordinate of the optimal value in the Rx direction, that is, the receiving parameter candidate area is calculated and stored by the controller 20 (step S24) and the procedure proceeds to step S25. In contrast, when there is no optimal value in the Rx direction for the read data in step S23 (No route in step S23), the procedure proceeds to step S25.

In step S25, the controller 20 selects a Rx parameter for one byte (1 Rx) and determines whether the Rx parameter is the optimal value (step S26). When the Rx parameter is the optimal value (Yes route in step S26), the controller 20 determines whether the optimal value is a first optimal value in the Tx (step S27). When this optimal value is the first optimal value in the Tx direction (Yes route in step S27), the controller 20 stores the coordinates of the Tx and Rx selected by the controller 20 as the coordinate of the first optimal value in the Tx direction (step S21) and the procedure proceeds to step S31. In contrast, when the optimal value is not the first optimal value in the Tx direction (No route in step S27), the procedure proceeds to step S31.

Further, in step S26, when the selected Rx parameter is not the optimal value (No route in step S26), the controller 20 determines whether the first optimal value in the Tx direction is stored (step S29). When the first optimal value is stored (Yes route in step S29), the coordinates of the selected Tx and Rx is stored as a coordinate of a last optimal value in the Tx direction (step S30) and the procedure proceeds to step S31. In contrast, when the first optimal value in the Tx direction is not stored (No route in step S29), the procedure proceeds to step S31.

In step S31, next one byte (1 Rx) is selected by the controller 20. Further, it is determined whether the selected byte exceeds F, that is, the maximum value by the controller 20 (step S32). When the selected byte does not exceed F (No route in step S32), the processing of step S25 for the selected byte is performed. In contrast, when the selected byte exceeds F (Yes route in step S32), the controller 20 counts up the read address by one (step S33) and determines whether the read address exceeds F, that is, the maximum value (step S34). When the read address does not exceed F (No route in step S34), the processing of step S22 for the one counted-up read address is performed. In contrast, when the read address exceeds F (Yes route in step S34), the coordinate of the optimal value in the Tx direction, that is, the transmitting parameter candidate area is calculated and stored by the controller 20 (step S35).

Continuously, by the controller 20, the optimal parameter (setting parameter) is calculated from the stored coordinates of the optimal values in the Rx direction and the Tx direction (step S36). By the controller 20, the calculated optimal parameter is set in the device 2 which is the own device (step S37) and a packet is issued in order to set the optimal parameter in the device 3 which is the device of the other side (step S38), and the procedure is completed.

As described above, by the controller 20 of the second embodiment, the same effect as the information processing apparatus 1 of the first embodiment may be obtained.

Further, by the controller 20, the optimal setting parameter is determined based on the information on the error stored by the error count storage unit 22 and then set in the devices 2 and 3. Therefore, after setting the initial value in the device 2, the transmission test and the setting process may be automatized.

In addition, the setting value is efficiently set based on the transmission test and the testing result as a series of processing so that the evaluation of the testing result by the operator may be omitted. For example, it is possible to more significantly reduce a man hour in the evaluation of the trial production of the devices 2 and 3 than the information processing apparatus 1 of the first embodiment.

Further, by the controller 20, a point at which a more margin is allowed from the range of the transmittable area, that is, a centroid of the area is obtained. In this case, the optimal setting parameter (setting value) is determined based on the combinations of the receiving parameters and the transmitting parameters at the intersections of the obtained receiving parameter candidate areas and transmitting parameter candidate areas by the controller 20. Accordingly, for example, it is possible to select (determine) a setting parameter which has a wider acceptable range even when the environment of both the Txs 24 and 34 and the Rxs 25 and 35, for example, the environment of the communication line 10, is changed.

### [2-2] First Modification of Second Embodiment

In the first embodiment, each of the modifications, and the second embodiment, even though it is described that a trigger that starts the transmission test is the manual manipulation from the console 4, the invention is not limited thereto. For example, the function of the controller 20 of the second embodiment is applied to the first embodiment or each of the modifications and then using the increase in the error by the change in the temperature or voltage as a trigger, the processing from the starting of the evaluation by the transmission test to the setting of the setting value (optimal value) may be performed.

By doing this, even when the high speed serial transfer is unstable due to the environmental change in the devices 2 and 3 or the communication line 10, the optimal setting value is set to automatically stabilize the high speed serial transfer. Further, for example, even when the transmission characteristics are deteriorated by the environmental change during the actual operation, the setting parameter may be automatically changed and the stable transmission characteristics may be obtained.

### [2-3] Second Modification of Second Embodiment

In the first embodiment, each of the modifications, and the second embodiment, even though it is described that the functions of the devices 2 and 3 are an evaluating tool which may be used in the evaluation of the trial production of the devices 2 and 3, the invention is not limited thereto. For example, the functions of the devices 2 and 3 may be used as a test tool in the mass production of the device when the optimal transmission condition for every device is calculated. In this case, the operator that sets the initial value in the controller 20 through the console 4 may be a manufacturing manager. Further, the functions of the devices 2 and 3 may be used as a control tool of the setting value corresponding to the change in the transmission characteristic by the environmental change in the actual operation.

### [3] Others

Even though the preferred embodiments and modifications of the present invention have been described in detail, the present invention is not limited to the specific embodiments or modifications but various modification or changes may be allowed within the scope without departing from the spirit of the present invention.

For example, the first embodiment, the first to third modifications of the first embodiment, the second embodiment, and the first and second modifications of the second embodiment may be arbitrarily combined.

Further, even though it is described that the controller 20 of the first embodiment fixes the transmitting parameter and changes the receiving parameter when changing the setting parameter in the transmission test, the invention is not limited thereto. For example, the initial receiving parameter may be fixed and the transmitting parameter may be changed.

In addition, even though in the above-described second embodiment, it is described that the controller 20 determines the optimal setting parameter from the information on the error stored by the error count storage unit 22, the invention is not limited thereto. For example, the device 2 may have other configuration that performs operations as the controller 20 described in the second embodiment.

Further, all or some of the functions of the information processing apparatus 1 of the first and second embodiments and each of the modifications that include the controller 20 (the retention unit 201, the timing controller 202, the parameter generator 203, and the packet generator 204), the detector 21 (the CRC inspecting unit 21a, the packet reception counter 21b, and the error counter 21c), the timer 23, the parameter setting units 24b, 25b, 34b, and 35b, the packet analyzing unit 31, the PRBS generator 32, and the CRC adding unit 33 may be implemented by allowing a computer (including a CPU, an information processing apparatus, or various terminals) to execute a predetermined program.

The program, for example, is provided so as to be recorded in a computer-readable recording medium such as a flexible disc, a CD (CD-ROM, CD-R, or CD-RW), a DVD (DVD-ROM, DVD-RAM, DVD-R, DVD-RW, DVD+R, or DVD+RW), or a Blue-ray disc. In this case, the computer reads out the program from the recording medium to transmit and store the program to an internal storage device or an external storage device to be used.

Here, the computer is a concept including hardware and an OS (operating system) and refers to a hardware which operates under the control of the OS. Further, when the application program solely operates the hardware without the OS, the hardware corresponds to the computer. The hardware includes at least a micro processor such as a CPU and a unit that reads out the computer program recorded in the recording medium. The program includes a program code that allows the computer to implement the various functions of the information processing apparatus 1 of the first and second embodiments and each of the modifications. Further, a part of the functions may be implemented by the OS rather than the application program.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a first transmitting device and a second transmitting device which are connected through a communication line, wherein
the first transmitting device includes:
a controller that generates setting information concerning transmission and reception of data in the first and second transmitting devices and transmits the generated setting information to the second transmitting device;
a detector that detects whether an error is included in data which is transmitted from the second transmitting device and received based on the setting information; and
a storage unit that stores information on the error detected by the detector, and
the second transmitting device includes:
a setting unit that sets transmission of data to be transmitted to the first transmitting device based on the setting information received from the controller; and
a generator that generates data in accordance with the setting by the setting unit to transmit the data to the first transmitting device.

2. The information processing apparatus according to claim 1, wherein
the setting information includes a transmitting parameter and a receiving parameter of data in the first and second transmitting devices,
the first transmitting device further includes a timer that measures a predetermined time, and
when the timer is expired, the controller generates setting information in which at least one of the transmitting parameter and the receiving parameter is changed, transmits the generated setting information to the second transmitting device and resets the timer.

3. The information processing apparatus according to claim 2, wherein the controller determines a setting value concerning transmission and reception of data between the first transmitting device and the second transmitting device through the communication line based on the information on the error which is stored in the storage unit, sets the setting value in the first transmitting device, and transmits the determined setting value to the second transmitting device to be set.

4. The information processing apparatus according to claim 3, wherein
the storage unit stores the information on the error detected by the detector so as to be associated with the transmitting parameter and the receiving parameter, and
the controller obtains a candidate area of the combination of the transmitting parameter and the receiving parameter from the information on the error stored by the storage unit, obtains a center of every transmitting parameter in the receiving parameter direction in the candidate area as a receiving parameter candidate area, obtains a center of every receiving parameter in the transmitting parameter direction in the candidate area as a transmitting parameter candidate area, and determines the setting value based on the combination of the receiving parameter and the transmitting parameter at the intersection of the receiving parameter candidate area and the transmitting parameter candidate area.

5. The information processing apparatus according to claim 2, wherein
the second transmitting device further includes an adding unit that adds error detecting information to the data generated by the generator,
the detector detects whether an error is included in received data based on the error detecting information which is added to the data received from the second transmitting device, and counts the error when the error is included, and
the information on the error is a count value of an error when the timer is expired.

6. The information processing apparatus according to claim 5, wherein the detector allows the storage unit to store a maximum count value when the data is not received from the second transmitting device until the timer is expired after the setting information is transmitted to the second transmitting device by the controller.

7. A testing method in an information processing apparatus including a first transmitting device and a second transmitting device which are connected through a communication line, the testing method comprising:
generating, in the first transmitting device, setting information concerning transmission and reception of data in the first and second transmitting devices and transmitting the generated setting information to the second transmitting device;
setting, in the second transmitting device, transmission of data to be transmitted to the first transmitting device based on the setting information received from the first transmitting device;
generating, in the second transmitting device, data in accordance with the setting of the transmission to transmit the generated data to the first transmitting device,
detecting, in the first transmitting device, whether an error is included in data which is transmitted from the second transmitting device and received based on the setting information; and
storing information on the detected error in a storage unit.

8. The testing method according to claim 7, wherein
the setting information includes a transmitting parameter and a receiving parameter of data in the first and second transmitting devices, and
in the first transmitting device, measuring a predetermined period of time, and when the time measurement is expired, generating setting information in which at least one of the transmitting parameter and the receiving parameter is changed, transmitting the generated setting information to the second transmitting device, and resetting the measurement of a predetermined period of time.

9. The testing method according to claim 8, wherein in the first transmitting device, determining a setting value concerning transmission and reception of data between the first transmitting device and the second transmitting device through the communication line based on the information on the error which is stored in the storage unit, setting the setting value to the first transmitting device, and transmitting the determined setting value to the second transmitting device to be set.

10. The testing method according to claim 9, wherein
the information on the detected error is stored in the storage unit so as to be associated with the transmitting parameter and the receiving parameter,
in the first transmitting device,
obtaining a candidate area of the combination of the transmitting parameter and the receiving parameter from the information on the error stored by the storage unit,
obtaining a center of every transmitting parameter in the receiving parameter direction in the candidate area as a receiving parameter candidate area, and a center of every receiving parameter in the transmitting parameter direction in the candidate area as a transmitting parameter candidate area, and
determining the setting value based on the combination of the receiving parameter and the transmitting parameter at the intersection of the receiving parameter candidate area and the transmitting parameter candidate area.

11. The testing method according to claim 8, wherein
in the second transmitting device, adding error detecting information to the generated data,
in the detecting process in the first transmitting device, detecting whether an error is included in received data based on the error detecting information which is added to the data received from the second transmitting device, and counting the error when the error is included, and
the information on the error is a count value of an error when the measurement of a predetermined period of time is expired.

12. The testing method according to claim 11, wherein in the detecting process in the first transmitting device, storing a maximum count value in the storage unit when the data is not received from the second transmitting device until the measurement of a predetermined period of time is expired after the setting information is transmitted to the second transmitting device.

13. A computer-readable recording medium having stored therein a testing program for causing a computer including a first transmitting device and a second transmitting device which are connected through a communication line, to execute a process comprising:
generating, in the first transmitting device, setting information concerning transmission and reception of data in the first and second transmitting devices and transmitting the generated setting information to the second transmitting device;
setting, in the second transmitting device, transmission of data to be transmitted to the first transmitting device based on the setting information received from the first transmitting device;
generating, in the second transmitting device, data in accordance with the setting of the transmission to transmit the generated data to the first transmitting device,
detecting, in the first transmitting device, whether an error is included in data which is transmitted from the second transmitting device and received based on the setting information; and
storing information on the detected error in a storage unit.

14. The computer-readable recording medium according to claim 13, wherein
the setting information includes a transmitting parameter and a receiving parameter of data in the first and second transmitting devices, and
the computer readable recording medium for causing the computer to execute the process further comprising:
in the first transmitting device, measuring a predetermined time, and
when the time measurement is expired, generating setting information in which at least one of the transmitting parameter and the receiving parameter is changed, transmitting the generated setting information to the second transmitting device and resetting the measurement of a predetermined period of time.

15. The computer-readable recording medium according to claim 14, wherein the computer readable recording medium for causing the computer to execute the process further comprising:
in the first transmitting device, determining a setting value concerning transmission and reception of data between the first transmitting device and the second transmitting device through the communication line based on the information on the error which is stored in the storage unit, setting the setting value in the first transmitting device, and transmitting the determined setting value to the second transmitting device to be set.

16. The computer-readable recording medium according to claim 15, wherein
the information on the detected error is stored in the storage unit so as to be associated with the transmitting parameter and the receiving parameter, and
the computer readable recording medium for causing the computer to execute the process further comprising:
obtaining, in the first transmitting device, a candidate area of the combination of the transmitting parameter and the receiving parameter from the information on the error stored by the storage unit,
obtaining a center of every transmitting parameter in the receiving parameter direction in the candidate area as a receiving parameter candidate area, and a center of every receiving parameter in the transmitting parameter direction in the candidate area as a transmitting parameter candidate area, and
determining the setting value based on the combination of the receiving parameter and the transmitting parameter at the intersection of the receiving parameter candidate area and the transmitting parameter candidate area.

17. The computer-readable recording medium according to claim 14, wherein the computer readable recording medium for causing the computer to execute the process further comprising:
in the second transmitting device, adding error detecting information to the generated data,
in the detecting process in the first transmitting device, detecting whether an error is included in received data based on the error detecting information which is added to the data received from the second transmitting device, and counting the error when the error is included, and
the information on the error is a count value of an error when the measurement of a predetermined period of time is expired.

18. The computer-readable recording medium according to claim 17, wherein
in the detecting process in the first transmitting device, storing a maximum count value in the storage unit when the data is not received from the second transmitting device until the measurement of a predetermined period of time is expired after the setting information is transmitted to the second transmitting device.
